(19) United States
(12) Patent Application Publication
(10) Pub. No.: US 2025/0368229 A1
(43) Pub. Date: Dec. 4, 2025

(54) POWER MANAGEMENT SYSTEM, POWER MANAGEMENT METHOD, AND STORAGE MEDIUM STORING POWER MANAGEMENT PROGRAM

(71) Applicant: DENSO CORPORATION, Kariya-city (JP)

(72) Inventors: Koichi TAKAGI, Kariya-city (JP); Toshiaki HORAI, Kariya-city (JP); Shiori MANEYAMA, Kariya-city (JP)

(21) Appl. No.: 19/297,272

(22) Filed: Aug. 12, 2025

Related U.S. Application Data
(63) Continuation of application No. PCT/JP2024/005295, filed on Feb. 15, 2024.

(30) Foreign Application Priority Data
Mar. 8, 2023 (JP) 2023-035644
Jan. 18, 2024 (JP) 2024-006120

(51) Int. Cl. B60W 60/00; B60L 58/12; B60W 50/14

(52) U.S. Cl. CPC B60W 60/0023; B60L 58/12; B60W 50/14; B60W 60/0051; B60W 2050/146; B60W 2540/049

(57) ABSTRACT

A power management system is configured to calculate an amount of electric power for travel and an amount of consumption-related electric power based on a power consumption parameter representing electric power consumed in a vehicle, the amount of electric power for travel being consumed while the vehicle is traveling until reaching a destination, the amount of consumption-related electric power being required to execute a function of an in-vehicle device used until the destination is reached; create a power use plan for traveling to the destination; and determine whether it is appropriate to use the current power use plan. An updated power use plan that is different from a current power use plan is created when it is determined that the current power use plan is inappropriate.

### CROSS REFERENCE TO RELATED APPLICATION

The present application is a continuation application of International Patent Application No. PCT/JP2024/005295 filed on Feb. 15, 2024 which designated the U.S. and claims the benefit of priority from Japanese Patent Application No. 2023-035644 filed on Mar. 8, 2023 and Japanese Patent Application No. 2024-006120 filed on Jan. 18, 2024. The entire disclosures of all of the above applications are incorporated herein by reference.

### TECHNICAL FIELD

The present disclosure relates to a power management system, a power management method, and a power management program.

### BACKGROUND

In recent years, vehicles, such as hybrid vehicles (HVs), plug-in hybrid vehicles (PHVs), and electric vehicles (EVs), have become widespread, but there are limits to the amount of storage in drive batteries. For this reason, there is a possibility that sufficient electric power for a vehicle to reach its destination from the current location cannot be ensured. To solve this type of problem, the technique described in a related art has been proposed. According to the technique described in the related art, a predicted value of a remaining energy amount of a battery when an electric vehicle reaches a destination is calculated, and notification based on the predicted value of the remaining energy amount is performed by a notification apparatus.

### SUMMARY

According to an aspect of the present disclosure, a power management system includes at least one of (i) a circuit and (ii) a processor with a memory storing computer program code executable by the processor, the at least one of the circuit and the processor configured to cause the power management system to: calculate an amount of electric power for travel and an amount of consumption-related electric power based on a power consumption parameter representing electric power consumed in a vehicle, the amount of electric power for travel being consumed while the vehicle is traveling until reaching a destination, the amount of consumption-related electric power being required to execute a function of an in-vehicle device used until the destination is reached; create a power use plan for traveling to the destination based on the amount of electric power for travel and the amount of consumption-related electric power; and determine, based on the power consumption parameter, whether it is appropriate to use a current power use plan. An updated power use plan that is different from a current power use plan is created when it is determined that the current power use plan is inappropriate.

### BRIEF DESCRIPTION OF DRAWINGS

Objects, features and advantages of the present disclosure will become more apparent from the following detailed description made with reference to the accompanying drawings. In the drawings:

FIG. 1 is a block configuration diagram schematically showing a power management system for a vehicle according to a first embodiment;

FIG. 2 is a diagram schematically showing main functions of an electronic control unit (ECU);

FIG. 3 is a flowchart schematically illustrating a processing operation;

FIG. 4 is a first diagram schematically showing a change mode of an amount of electric power;

FIG. 5 is a second diagram schematically showing the change mode of an amount of electric power;

FIG. 6 is a flowchart schematically illustrating a processing operation during travel of the vehicle;

FIG. 7 is a third diagram schematically showing the change mode of the amount of electric power;

FIG. 8 is a fourth diagram schematically showing the change mode of the amount of electric power;

FIG. 9A is a fifth diagram schematically showing the change mode of the amount of electric power;

FIG. 9B is a first flowchart schematically illustrating a processing operation in a modification of the first embodiment;

FIG. 9C is a second flowchart schematically illustrating the processing operation in the modification of the first embodiment;

FIG. 10 is a flowchart schematically illustrating a processing operation according to a second embodiment;

FIG. 11 is a first example of a display mode according to a third embodiment;

FIG. 12 is a flowchart schematically illustrating a processing operation;

FIG. 13 is a second example of the display mode;

FIG. 14 is a third example of the display mode;

FIG. 15 is a first example of a display mode according to a fourth embodiment;

FIG. 16 is a flowchart schematically illustrating a processing operation;

FIG. 17 is a second example of the display mode;

FIG. 18 is a third example of the display mode; and

FIG. 19 is a fourth example of the display mode.

### DETAILED DESCRIPTION

In recent years, with the development of vehicle driving support technology and automated driving technology, when a destination is input, it is becoming possible to automatically move from the current location to the destination without a driver operating the vehicle. In this case, a vehicle occupant has more time to spend in the vehicle interior, and has more opportunities and time to enjoy entertaining pastimes.

It is conceivable that, when enjoying entertainment in the vehicle interior, the vehicle occupant enjoys a movie projected on a display apparatus installed in advance in the vehicle. It is conceivable that the vehicle occupant brings a mobile terminal such as a smartphone, a tablet terminal, or a laptop computer into the vehicle interior and enjoys entertainment while charging the mobile terminal in the vehicle interior. At this time, the amount of power consumption required to reach the destination varies depending on the needs of the vehicle occupant. Therefore, it is desirable to manage power consumption used in the vehicle so as to meet the needs.

In the technique described in a related art, the notification is merely passive notification, and notification control is started at a timing when the upper limit of the amount of use is asymptotically approached. Therefore, the vehicle occupant can use electric power without concern about electric power until a system notifies that the upper limit of the usage fee has been asymptotically approached.

In this case, even if some event occurs in which a large amount of electric power needs to be consumed when the amount of electric power is close to the upper usage limit, there is a possibility that electric power cannot be consumed due to the usage limit. Conversely, there is a possibility that the vehicle occupant pays excessive attention to such power consumption and hesitates to consume electric power, although there is a margin for power consumption before the destination is reached.

The present disclosure provides a power management system, a power management method, and a power management program that enable appropriate management of an amount of power consumption until a destination is reached.

According to one aspect of the present disclosure, a power management system includes: a calculation section configured to calculate an amount of electric power for travel and an amount of consumption-related electric power based on a power consumption parameter representing electric power consumed in a vehicle, the amount of electric power for travel being consumed while the vehicle is traveling until reaching a destination, the amount of consumption-related electric power being required to execute a function of an in-vehicle device used until the destination is reached; a generation section configured to create a power use plan for traveling to the destination based on the amount of electric power for travel and the amount of consumption-related electric power; and a determination section configured to determine, based on the power consumption parameter, whether it is appropriate to use the current power use plan. The generation section creates an updated power use plan that is different from a current power use plan, when the determination section determines that the current power use plan is inappropriate.

For example, when updating is performed on a power consumption parameter that consumes electric power in the vehicle, such as a change in the number of vehicle occupants or their riding state, or information on an operation input through an operation input section (e.g., personal setting information, an air conditioner setting state, or personal preference information (information on a viewing schedule for entertainment content such as movies)), the determination section determines, based on the power consumption parameter, whether the use of the current power use plan is appropriate.

When the determination section determines that the use is not appropriate, the generation section creates a power use plan for update that is different from the current power use plan. For this reason, even if some event occurs in which a large amount of electric power needs to be consumed when the amount of electric power is close to the upper usage limit, the system can consume electric power in response to this event. This enables the amount of power consumption to be appropriately managed until the destination is reached.

As described in another aspect of the present disclosure, the notification control section controls notification to a vehicle occupant of a power use plan for update, so that the vehicle occupant can be made aware of the amount of power consumption until the destination is reached. When there is a margin in the amount of power consumption, the vehicle occupant is not likely to pay excessive attention to such power consumption and can consume electric power with a margin until reaching the destination.

Hereinafter, some embodiments of a power management system 1 for a vehicle will be described with reference to the drawings. In each of the embodiments described below, configurations that perform the same or similar operations are denoted by the same or similar reference numerals, and description thereof is omitted as necessary.

### First Embodiment

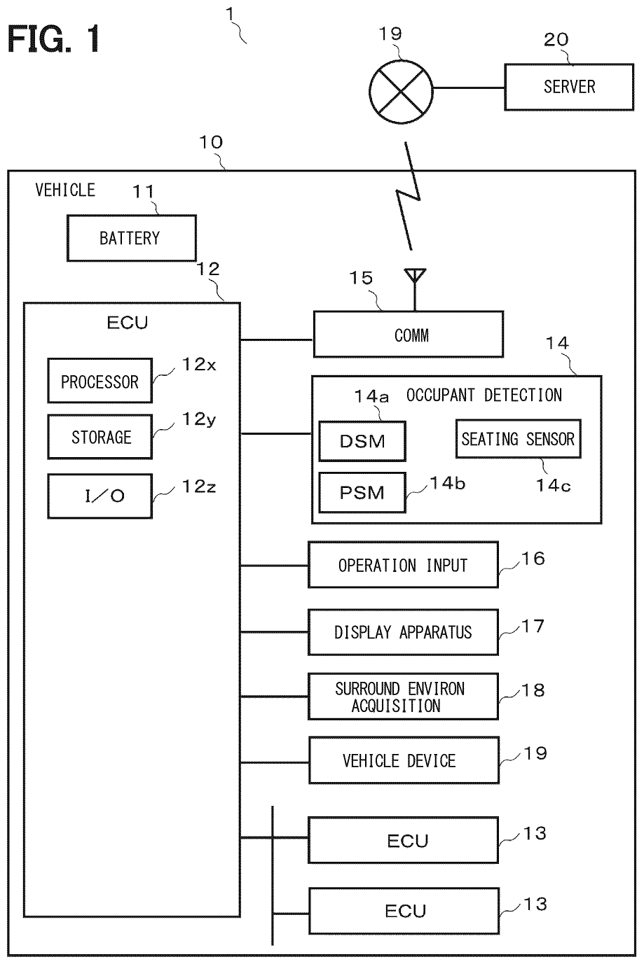

A power management system 1 shown in FIG. 1 is installed in a vehicle 10. Here, the vehicle 10 is shown as an electric vehicle 10 (EV), but may also be applied to a hybrid vehicle (HV), a plug-in hybrid vehicle (PHV, PHEV), or the like, in which an internal combustion engine is combined.

An in-vehicle device that operates by receiving power supply from a battery 11 is installed in the vehicle 10. Examples of the in-vehicle devices shown here include an occupant detection section 14, a communication section 15, an operation input section 16, a display apparatus 17, a surrounding environment acquisition section 18, and other vehicle devices 19. An ECU represents an electronic control unit and is an abbreviation of electronic control unit. The battery 11 refers to an auxiliary battery for supplying electric power to ECUs 12, 13 together with an assembled battery formed by connecting battery cells in series as a power source for travel.

The ECU 12 is connected via a network to other ECUs 13. The ECUs 12, 13 may be classified into an ECU of a display system that controls notification to a vehicle occupant of information, an ECU of a surrounding monitoring system that acquires a state of a surrounding environment of the vehicle 10 and monitors the surroundings of the vehicle 10, and an ECU of a travel control system that controls the travel of the vehicle 10. An integrated ECU may be configured to integrate some or all of the functions of these ECUs 12, 13. Here, the ECU 12 for implementing the functions of the present application will be described with reference numeral 12 different from that of each of the other ECUs 13, but the ECU 12 may be configured by integrating functions included in the other ECUs 13.

The ECU of the travel control system includes an electronic control unit that controls the electric travel of the vehicle 10, using a vehicle traveling motor in accordance with a driver's driving operation, or an electronic control unit that implements an automated driving mode in accordance with levels of automated driving at various stages. This enables travel control of the vehicle 10 to be performed in each driving mode: manual driving or automated driving at a predetermined level.

The occupant detection section 14, the communication section 15, the operation input section 16, and the display apparatus 17 are connected to the ECU 12. The occupant detection section 14 shows a configuration to detect a vehicle occupant, using various sensors such as a DSM 14a, a PSM 14b, a seating sensor 14c, and a seatbelt sensor (not shown).

The DSM 14a is a so-called driver status monitor, and refers to a high-performance recognition system for automatically recognizing the face and body of the driver with a camera and detecting the driving state of the driver. The DSM 14a detects the driver's status with high accuracy. The PSM 14b is a so-called passenger status monitor, and automatically recognizes the face and body of each of vehicle occupants other than the driver with a camera, detects the state of the vehicle occupant, and detects the status of the other vehicle occupants with high performance. The seating sensor 14c is disposed on each of seat cushions on which the vehicle occupant is seated, and detects a seat on which the vehicle occupant is seated. The seatbelt sensor detects the seatbelt wearing state of the vehicle occupant. Using such various devices, the occupant detection section 14 can detect whether the vehicle occupant is seated on any seat, the positions of the face and a part of the body of the driver or another vehicle occupant, and also the state of the vehicle occupant, such as feelings, by monitoring the vehicle occupant.

The communication section 15 is configured by a DCM for communication connection with the outside of the vehicle 10, and enables communication processing through a communication network outside the vehicle 10. DCM is an abbreviation of data communication module. The operation input section 16 is configured by, for example, a touch panel formed on a display screen of the display apparatus 17 or a mechanical switch provided beside the display screen, and receives an operation input by the driver or the vehicle occupant. For example, the operation switch includes a switch for switching among a manual driving mode, a driving support mode, and an automated driving mode. When there is an operation input on the operation input section 16, the ECU 12 receives the operation input through an input/output interface (I/O) 12z, and the ECU 12 performs control based on the operation signal of the operation input section 16.

The display apparatus 17 is configured by, for example, a center information display (CID) including a liquid crystal display, an organic EL display, or the like. The display apparatus 17 can display various kinds of content based on the control of the ECU 12.

The surrounding environment acquisition section 18 is configured by a front view camera, a side view camera, a corner view camera, a back view camera, an electronic mirror, a laser radar using Light Detection And Ranging (LiDaR), and/or a millimeter wave radar, which image the surroundings of the vehicle 10. The surrounding environment acquisition section 18 can acquire the state of the surrounding environment of the vehicle 10. When the state of the surrounding environment acquired by the surrounding environment acquisition section 18, for example, imaging information, is input through the I/O 12z, the ECU 12 stores the state in a storage section 12y. The ECU 12 and the other ECUs 13 can implement various assist functions, for example, a radar cruise control function (LCC), using the state of the surrounding environment acquired by the surrounding environment acquisition section 18. The radar cruise control function refers to a function of performing follow-up travel relative to the vehicle 10 traveling in front of the own vehicle 10, while maintaining a constant interval therebetween. In addition, the ECU 12 and the other ECUs 13 control a driving actuator related to manual driving when switching is made to the manual driving mode. When switching is made to the driving support mode or the automated driving mode, the ECU 12 or the other ECUs 13 control the driving actuator (not shown) to implement predetermined driving support or implement automated driving in accordance with a level.

Examples of the other vehicle devices 19 include an air conditioner unit that adjusts air conditioning in the vehicle interior. Examples of the other vehicle devices 19 include an entertainment device that includes a mass storage apparatus such as a digital versatile disc (DVD), a Blu-ray disk, a hard disk drive (HDD), or a semiconductor memory and provides a medium such as a movie recorded in the storage apparatus. Examples of the other vehicle devices 19 include a broadcasting device that receives and broadcasts television radio waves and radio waves, and a speaker unit that outputs sound into the vehicle interior.

The ECU 12 includes a microcomputer including: a processor 12x, such as a microcontroller unit (MCU) core; various storage sections 12y, such as a cache memory, a random-access memory (RAM), a read-only memory (ROM), and a solid-state drive (SSD); the I/O 12z; and a bus that connects these components. The storage section 12y refers to a non-transitory tangible storage medium that non-transiently stores computer-readable programs and data. The non-transitory tangible storage medium is implemented by a semiconductor memory or the like. The ECU 12 may be configured with a large-capacity external storage apparatus such as a DVD, an HDD, or an SSD connected externally as the storage section 12y. The other ECUs 13 can also be implemented by similar configurations.

Next, a function of an application program stored in the storage section 12y will be described. The ECU 12 executes the application program stored in the storage section 12y, using the processor 12x. When a waypoint or a destination is operationally input by the operation of the operation input section 16, the ECU 12 implements a navigation function of searching for a route to the destination through the waypoint with reference to map information M stored in the storage section 12y, and guiding the route. The map information M may be acquired from an external server 20.

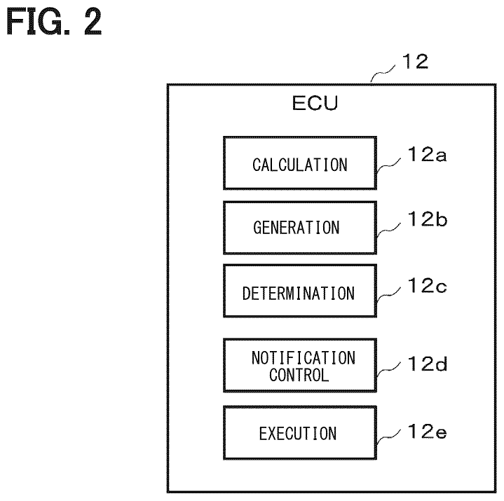

By executing the application program, the ECU 12 executes the navigation function of searching for a route to a destination and guiding the route. Further, by executing the application program, the ECU 12 implements functions as a calculation section 12a, a generation section 12b, a determination section 12c, a notification control section 12d, and an execution section 12e, as shown in FIG. 2. These functions are shown in the form of being implemented by one ECU 12, but the processing may be shared with other ECUs 13 and other vehicle devices 19 for the processing power of the internal physical resources.

The calculation section 12a calculates the amount of electric power for travel that is consumed during travel of the vehicle 10 until the destination is reached. The calculation section 12a calculates the amount of consumption-related electric power required to execute the function of the in-vehicle device (e.g., some or all of the in-vehicle devices 14 to 19) used until the destination is reached. Based on a power consumption parameter that consumes electric power inside the vehicle 10, the calculation section 12a calculates the amount of electric power.

The power consumption parameter refers to an element that consumes electric power in the vehicle. The power consumption parameter includes an element that consumes electric power based on at least one of the following pieces of occupant information: information on the driving operation of the vehicle 10 by the driver, information on the operation of the vehicle device 19 by the vehicle occupant, the state of the vehicle occupant such as a feeling, the number of vehicle occupants, and the preference of the vehicle occupant.

The power consumption parameter is a parameter that changes the amount of power consumption in accordance with various factors inside and outside the vehicle. For example, in the case of an external factor, the power consumption parameter related to the amount of power consumption also changes depending on a factor such as weather, due to a road closure on a route, a change in load weight, or a driver change. For example, when the weather becomes hotter, the amount of power consumption by an air conditioner increases. When it rains, the frequency of use of a wiper increases and the amount of power consumption increases. When a route is set and the vehicle passes through a detour due to a road closure, the amount of power consumption also changes in accordance with the integrated distance and a change in gradient. When the driver is changed during travel, the amount of power consumption also changes depending on the driving habit of the driver and other factors. In the case of an internal factor, a change in the amount of power consumption due to aging of various components in the vehicle may be cited.

### (Description of Occupant Information)

Here, the occupant information will be described. The occupant information represents a state such as a feeling obtained by the occupant detection section 14 monitoring the vehicle occupant, and indicates a setting state and priorities of preferences of the vehicle occupant. The setting state of the preference of the vehicle occupant indicates setting information and history information thereof, which are operationally input in advance through the operation input section 16 before or during driving of the vehicle 10. The setting state of the preference of the vehicle occupant may not be personalized for each individual, and may be set for each group such as the owner of the vehicle 10 and family members, regarding data such as an attribute, an action, and an operation history of the vehicle occupant.

The server 20 can communicate with a large number of vehicles 10 through the communication section 15, and receives and stores preference data set in each vehicle 10 from the communication sections 15 of a large number of vehicles 10. The server 20 learns in advance information on an operation input through the operation input section 16, the information being stored in the storage sections 12y of a large number of vehicles 10, sets preference priorities in descending order of setting frequency, and sets this information as occupant information.

For example, when the server 20 learns information transmitted from a large number of vehicles 10 and learns that “the owner of this vehicle 10 often watches a movie on an expressway”, this fact is notified to the ECU 12 of the corresponding vehicle 10. The ECU 12 stores this fact in the storage section 12y as occupant information. A part or all of the processing content of the server 20 may be performed on the side of the ECU 12 of each vehicle 10. In the above description, the preference priorities have been set as occupant information by relatively comparing a large number of vehicle occupants, but the present invention is not restricted thereto. For example, the ECU 12 may set preference priorities in descending order of setting frequency based on results of individual learning of vehicle occupants, and may set this information as occupant information.

### (Description of Method for Calculating Amount of Electric Power for Travel)

Next, a method for calculating the amount of electric power for travel will be described. The vehicle 10 travels as the vehicle 10 starts manual driving by the driver's operation. At this time, the degree of decrease in the remaining amount of electric power stored in the battery 11 also changes depending on a status of accelerator depression and a state of brake depression by the driver. The degree of decrease in the remaining amount of electric power stored in the battery 11 also changes depending on the riding state of the vehicle occupant and the increase or decrease in the number of vehicle occupants.

Further, in the ECU 12 of the vehicle 10, a setting is made for vehicle information related to driving assistance, for example: a normal mode for normal travel in which fuel consumption performance, quietness, and motion performance are well balanced; a power mode for implementing strong acceleration by increasing the response to an accelerator operation; and an eco-drive mode for reducing air conditioner operation while moderating the drive force in response to an accelerator operation and placing importance on energy saving. In the ECU 12 of the vehicle 10, as the vehicle information, a setting is made for, for example, current device information inside the vehicle 10, such as which device is in operation, whether the mobile terminal 8 or the like is connected to a charging port and is being charged, the set temperature of the air conditioner, and the amount of power consumption associated with the set temperature.

Based on this type of vehicle information and the degree of up-and-down inclination of the searched scheduled travel route until the destination is reached, the degree of decrease in the remaining amount of electric power of the battery 11 until the destination is reached changes. Based on such vehicle information and power consumption parameters such as the travel status of the scheduled travel route, the calculation section 12a calculates the amount of electric power for travel until the destination is reached.

In both manual driving and automated driving, based on the preference, the vehicle occupant uses another vehicle device 19 to perform the temperature adjustment function of the air conditioner, or to use the entertainment device or the broadcasting device. Therefore, the calculation section 12a calculates the amount of consumption-related electric power until the destination is reached, based on the operation information on the in-vehicle devices (e.g., 14 to 19), including another vehicle device 19 as described above, the operation input information, and the power consumption parameter according to the preference of the vehicle occupant.

The generation section 12b is provided to create power use plans K1, K2 for traveling to the destination based on the amount of electric power for travel and the amount of consumption-related electric power. The determination section 12c is provided to determine, based on the power consumption parameter, whether the use of the current power use plan K2 is appropriate, for example, whether the current plan cannot be continued.

When the determination section 12c determines that the use is not appropriate, for example, that the current plan cannot be continued, the generation section 12b creates a power use plan for update K2a different from the current power use plan K2. The notification control section 12d is provided to control notification to the vehicle occupant of the power use plans K1, K2 and/or the power use plan for update K2a. The execution section 12e indicates a function of executing the power use plan K1, K2, or K2a after confirming with the vehicle occupant as necessary.

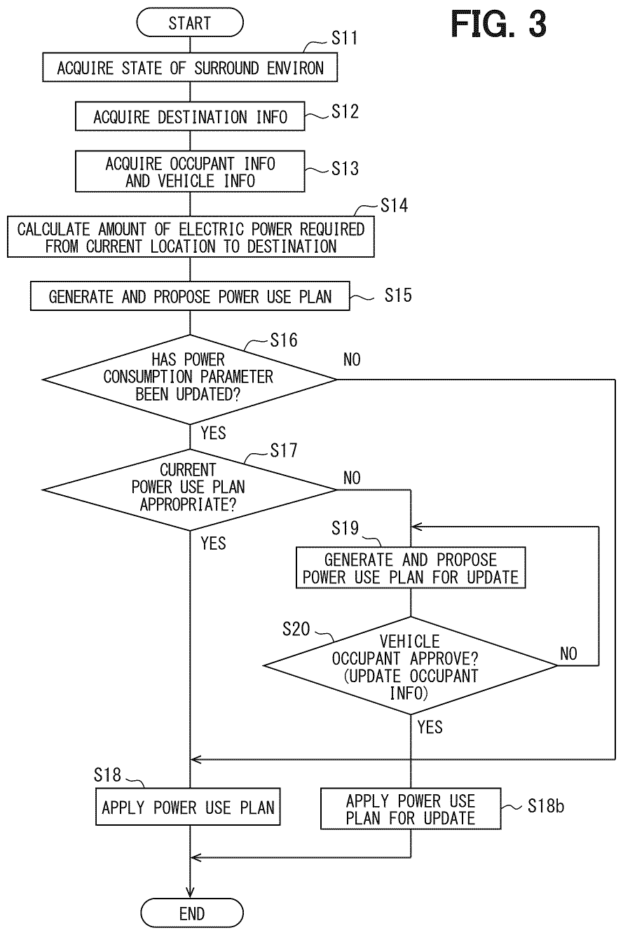

Hereinafter, a specific example of the function will be described with reference to a flowchart. When the ignition switch or the power switch of the vehicle 10 is turned on by the driver's operation, power is supplied from the battery 11 to the vehicle 10, and the vehicle device 19 such as the ECU 12 is activated. The ECU 12 executes processing shown in FIG. 3 after activation.

When the driver inputs a destination by operating the operation input section 16 and the driver performs an operation related to travel, the ECUs 12, 13 start driving control. As shown in FIG. 3, in S11, the ECU 12 acquires the state of the surrounding environment, using the surrounding environment acquisition section 18, and in S12, acquires destination information, using the operation input section 16.

In S13, the ECU 12 acquires occupant information and vehicle information, using the other ECUs 13, the other vehicle devices 19, and the occupant detection section 14. As described above, the occupant information indicates information on the driving operation of the vehicle 10 by the driver, information on the operation of the in-vehicle device by the vehicle occupant, the riding state of the vehicle occupant, the number of vehicle occupants, and the preference of the vehicle occupant.

In S14, the calculation section 12a of the ECU 12 considers the occupant information and the vehicle information as power consumption parameters, and calculates the amount of electric power required from the current location to the destination based on the power consumption parameters. In S15, the generation section 12b of the ECU 12 creates the power use plan K1. The power use plan K1 is obtained in a time-series manner by integrating the amount of power consumption calculated by the calculation section 12a over the scheduled travel route to the destination in a time-series manner and subtracting the integrated amount from the current remaining amount of the battery 11.

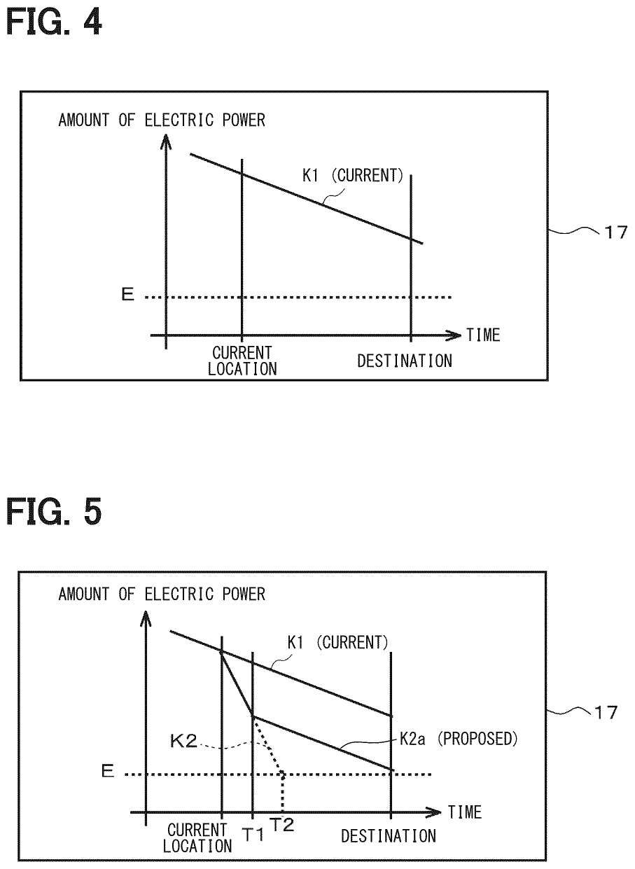

As shown in FIG. 4, a case where a power use plan K1 from the current location to the destination is prepared will be considered. The ECU 12 calculates a total amount of power consumption when assuming that the current power use plan K1 is carried out until the current power use plan K1 reaches the destination, and determines whether there is a margin equal to or greater than a predetermined remaining amount E that allows for a margin amount of electric power. When the ECU 12 determines that there is a margin equal to or larger than the remaining amount E, in S15, the notification control section 12d of the ECU 12 notifies the vehicle occupant of the current power use plan K1 and proposes the current power use plan K1, and controls notification so as to urge the carrying out of the current power use plan K1.

For example, as shown in FIG. 4, the notification control section 12d displays and proposes the current power use plan K1 on the display screen of the display apparatus 17, and notifies that there is a margin greater than a predetermined remaining amount E that allows for a margin amount of electric power until the destination is reached when the current power use plan K1 is carried out. This enables the notification control section 12d to control notification so as to urge the carrying out of the current power use plan K1.

Thereafter, in S16, the ECU 12 determines whether the power consumption parameter has been updated. When the power consumption parameter has not been updated in S16, the ECU 12 determines NO in S16 and applies the power use plan K1 proposed in S18. The ECU 12 performs control related to the power use plan K1, using the execution section 12e.

For example, when the vehicle occupant such as the driver gives an instruction to start the use of the air conditioner unit together with the entertainment device while the vehicle 10 is stopped before travel, it is assumed that a large amount of electric power is consumed until the destination is reached. At this time, the ECU 12 calculates the amount of power consumption by the calculation section 12a. In S15, the ECU 12 creates a power use plan K2 based on the calculation result of the calculation section 12a. For example, the ECU 12 receives the instruction to start the use of the vehicle device 19, determines that the power consumption parameter has been updated in S16, and determines YES in S16. In S17, the ECU 12 determines whether the current power use plan K2 is appropriate by the function of the determination section 12c.

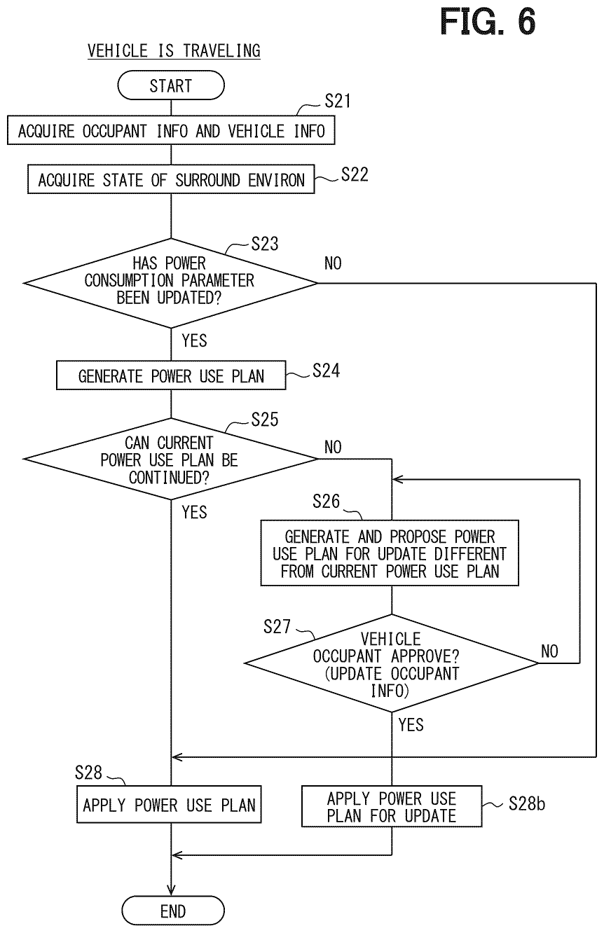

When the air conditioner unit is continuously used together with the entertainment device in the vehicle during travel of the vehicle from the current location to the destination, a large amount of electric power is continuously consumed. Thus, as a result of the calculation of the amount of electric power by the calculation section 12a, the amount of electric power of the battery 11 may reach the predetermined remaining amount E at an intermediate point T2 between the current location and the destination, as represented by the power use plan K2 indicated by a dashed line in FIG. 5. In this case, the ECU 12 determines that the current power use plan K2 is not appropriate by the function of the determination section 12c. In other words, the ECU 12 determines by the function of the determination section 12c that the use of the current power use plan K2 is not appropriate when a predetermined standard defined from the viewpoint of security or safety is exceeded.

When the determination section 12c determines that the current plan is not appropriate and cannot be continued, the ECU 12 determines NO in S17, and the generation section 12b of the ECU 12 creates a power use plan for update K2a different from the current power use plan K2 in S19.

For example, when the generation section 12b creates the power use plan for update K2a indicated by a solid line in FIG. 5, the notification control section 12d notifies and proposes the power use plan for update K2a on the display screen of the display apparatus 17 in S19. The notification control section 12d may notify a proposal such as, “Electric power will be consumed more than scheduled. Although electric power can be used up to point T1 (place name, etc.), if the travel of the vehicle 10 continues, how about refraining from using the air conditioner until the destination is reached?”, or a proposal such as, “How about reducing the use of electric power?” As a result of the notification and proposal by the notification control section 12d, when the vehicle occupant gives approval by an operation input through the operation input section 16 in S20, the power use plan for update K2a is applied in S18b. The ECU 12 controls the power use plan for update K2a, using the execution section 12e.

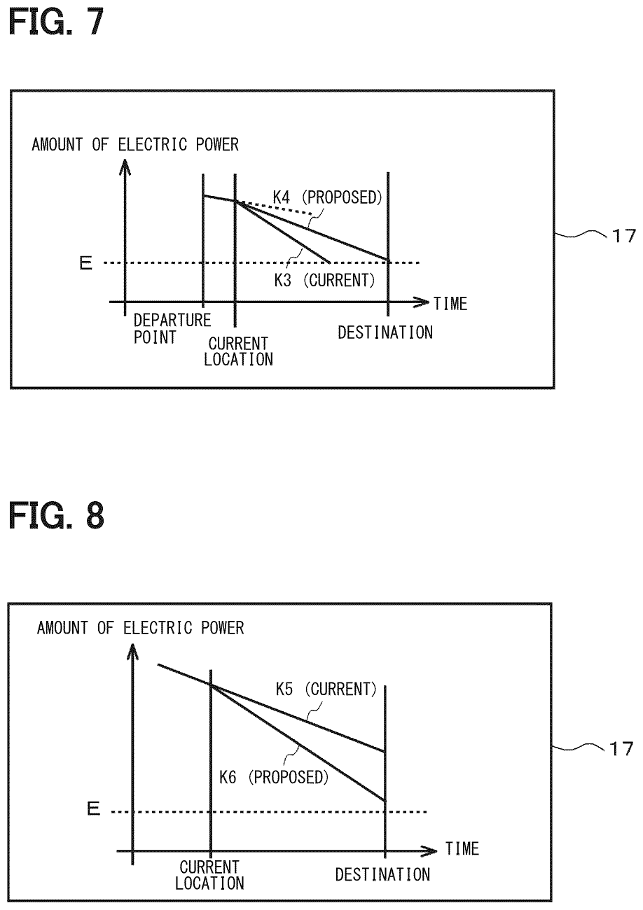

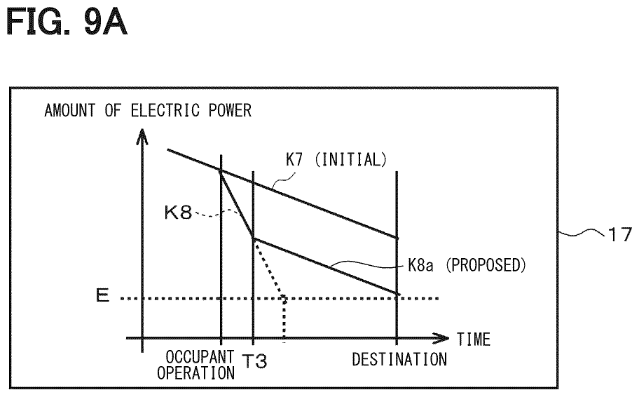

These processes are also executed during travel of the vehicle 10, as shown in FIGS. 6 and 7. For example, when the vehicle occupant makes an additional operation input during travel of the vehicle 10, a larger amount of electric power than the previous scheduled plan begins to be consumed during travel of the vehicle 10. In such a case, the processing is similarly executed.

Even during travel of the vehicle 10, the ECU 12 acquires occupant information and vehicle information in S21, and acquires the state of the surrounding environment in S22. In S23, the ECU 12 determines whether the power consumption parameter has been updated.

During travel of the vehicle 10 toward the destination, a power use plan (e.g., K1 in this case) has already been prepared. When there is no active change input of the power use plan K1 by the vehicle occupant, but an action estimated to be a change, that is, an action of consuming a large amount of electric power, is present, it is determined in S23 that the power consumption parameter has been updated.

For example, as shown in FIG. 7, the amount of electric power of the battery 11 gradually decreases from the departure point during travel of the vehicle 10. During travel of the vehicle 10, when the vehicle occupant starts movie watching and the use of the air conditioner is returned to a stronger setting, the amount of power consumption increases. In this case, the degree of decrease in the amount of electric power stored in the battery 11 increases.

In S24, the ECU 12 creates a power use plan K3 on condition that the power consumption parameter has been updated. The current power use plan K3 is referenced. In S25, the ECU 12 determines whether the current power use plan K3 can be continued and used.

For example, in the current power use plan K3, the ECU 12 determines that the current power use plan K3 reaches the predetermined remaining amount E before the current power use plan K3 reaches the destination, and determines that the current power use plan K3 cannot be continued and is not appropriate. In S26, the ECU 12 creates a power use plan for update K4 and proposes carrying out the power use plan for update K4 to the vehicle occupant.

In S26, the ECU 12 may perform notification control of a proposal of the power use plan for update K4, in which the degree of decrease in the remaining amount of electric power of the battery 11 is reduced, together with a message such as, “You can watch a movie until the destination is reached. How about weakening the temperature setting of the air conditioner?”, or may perform notification control of a proposal, such as “How about reducing the use of electric power?”.

When the vehicle occupant gives approval in S27, the ECU 12 applies the power use plan for update K4 in S28. As a result of the notification and proposal by the notification control section 12d, when the vehicle occupant gives approval by an operation input through the operation input section 16, the power use plan for update K4 is applied in S28b. The ECU 12 controls the power use plan for update K4 by the function of the execution section 12e.

### (Preference Priorities)

The preference priorities of the vehicle occupant may be set in the storage section 12y of the ECU 12 in advance through the operation input section 16. When settings are made in the storage section 12y such that the priority of movie watching is high and the priority of air conditioning adjustment by the air conditioner is low, in S26, the ECU 12 may propose to the vehicle occupant to give priority to movie watching by performing notification control of a message such as, “You can watch a movie until the destination is reached. How about weakening the temperature setting of the air conditioner?”.

Conversely, when settings are made in the storage section 12y such that the priority of air conditioning adjustment by the air conditioner is high and the priority of movie watching is low, in S26, the ECU 12 may propose to the vehicle occupant to give priority to the temperature setting of the air conditioner with a message such as, “The temperature setting of the air conditioner can be adjusted until the destination is reached. How about refraining from watching a movie?” The ECU 12 desirably proposes and notifies the preference of the vehicle occupant based on the priorities set in this manner.

In addition, when the ECU 12 determines that the current power use plan K3 will reach the predetermined remaining amount E before the destination is reached, and determines that the current power use plan K3 cannot be continued and is not appropriate, the power use plan for update K4 may be created so as to reduce the use of the air conditioner that adjusts the internal environment of the vehicle 10. In the case of adjusting the internal environment of the vehicle 10, the occupant detection section 14 may detect a seat without a vehicle occupant and may create and execute the power use plan for update K4 so as to adjust the output of air conditioning for the seat. In this case, the execution section 12e may automatically execute the power use plan for update K4 without controlling notification to the vehicle occupant of the power use plan for update K4, or without obtaining approval of the vehicle occupant in S27.

In addition, when a temperature adjustment function is provided in the seat cushion on which the vehicle occupant is seated, the ECU 12 may create and execute the power use plan for update K4 so as to adjust the use of electric power by controlling the output of the temperature adjustment function and adjusting a thermal feeling of a part of the body of the vehicle occupant The ECU 12 may create and execute the power use plan for update K4 so as to adjust the use of electric power by adjusting the output of air conditioning and blowing the wind to a part of the body of the vehicle occupant in a restricted manner. In this case, the execution section 12e may automatically execute the power use plan for update K4 without controlling notification to the vehicle occupant of the power use plan for update K4, or without obtaining approval of the vehicle occupant in S27.

### SPECIFIC EXAMPLES

The ECU 12 can acquire temperature information in the vehicle interior, using a temperature sensor. The ECU 12 may determine that the amount of electric power of the battery 11 is small and is not appropriate when the vehicle occupant feels relatively cold in the vehicle such as in winter. The ECU 12 may create and propose a power use plan for update K4 for a case where the heating function of the air conditioning and/or the heater function of the seat cushion are stopped to save electric power, and execute the power use plan for update K4 if approval is obtained. A power use plan for update K4 for a case where the target set temperature of the heating function of the air conditioning is lowered stepwise to save electric power may be created.

It may be determined that the amount of electric power can be ensured to the destination by operating another vehicle device 19, for example, the entertainment device, instead of stopping the heating function of the air conditioning and/or the heater function of the seat cushion. At this time, a power use plan for update K4 for a case where the entertainment device operates may be created and proposed, and may be executed when approval is obtained. The execution section 12e may execute the power use plan for update K4 without obtaining approval of the vehicle occupant.

Conversely, when there is a relatively sufficient amount of electric power of the battery 11 before the destination is reached, it may be determined that the vehicle occupant feels relatively cold in the vehicle in winter or the like. In this case, the heating function of the air conditioning and/or the heater function of the seat cushion can be enhanced by using that sufficient amount of electric power. Therefore, the ECU 12 may create and propose a power use plan for update K4 for a case where the amount of power consumption by the heating function of the air conditioning and/or the heater function of the seat cushion is increased, and execute the power use plan for update K4 for a case where approval is obtained. The execution section 12e may execute the power use plan for update K4 without obtaining approval of the vehicle occupant.

For example, it may be determined that the amount of electric power of the battery 11 is small and is not appropriate when the vehicle occupant feels relatively hot in the vehicle such as in summer. In this case, a power use plan for update K4 for a case where the air-conditioning cooling function is stopped to save electric power may be created and proposed, and the power use plan for update K4 may be executed if approval is obtained. A power use plan for update K4 for a case where the target set temperature of the cooling function of air conditioning is increased stepwise to save electric power may be created.

The ECU 12 may determine that the amount of electric power can be ensured to the destination by operating another vehicle device 19, for example, the entertainment device, instead of stopping the cooling function of air conditioning. In this case, a power use plan for update K4 for a case where the entertainment device operates may be created and proposed, and the power use plan for update K4 may be executed if approval is obtained. The execution section 12e may execute the power use plan for update K4 without obtaining approval of the vehicle occupant.

Conversely, when there is a relatively sufficient amount of electric power of the battery 11 before the destination is reached, it may be determined that the vehicle occupant feels relatively hot in the vehicle in summer or the like. The ECU 12 can enhance the cooling function of the air conditioner, for example, lower the target set temperature, by using that sufficient amount of electric power. Therefore, the ECU 12 may create and propose a power use plan for update K4 for a case where the amount of power consumption by the cooling function of the air conditioner is increased, and execute the power use plan for update K4 for a case where approval is obtained. The execution section 12e may execute the power use plan for update K4 without obtaining approval of the vehicle occupant.

According to the present embodiment, the power use plan for update (e.g., K4) is updated and executed by the execution section 12e without waiting for determination by the occupant of the vehicle 10. At this time, the notification control section 12d may notify how the power use plan will be updated (e.g., K3 to K4) such that a point of change in the power use plan before and after the update (e.g., K3 to K4) is understood.

### First Modification

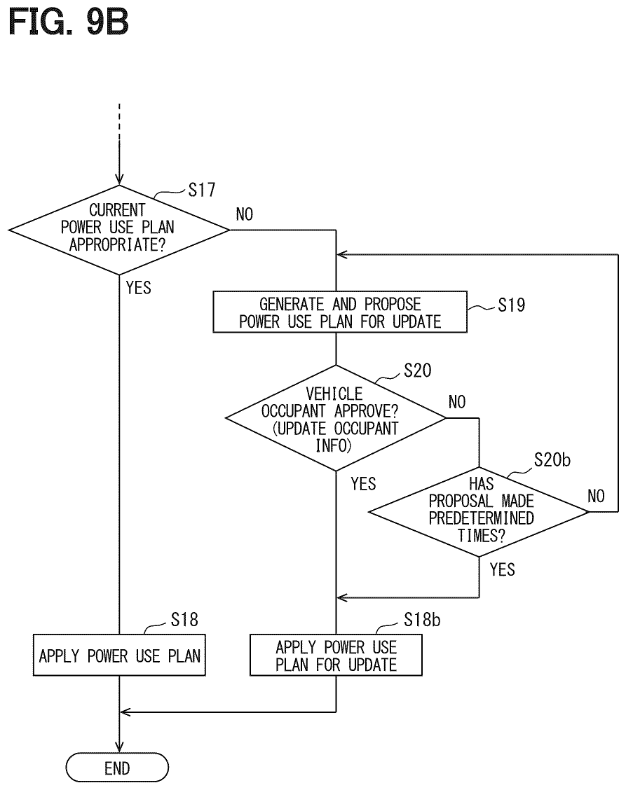

Unlike the case where there is no margin in the amount of electric power described above, the ECU 12 may determine that there is a margin significantly greater than the predetermined remaining amount E in a power use plan T5 at the current time as a result of calculating the total amount of power consumption, as shown in FIG. 8. In such a case, based on the preference of the vehicle occupant in S19 of FIG. 3 or S26 of FIG. 6, the ECU 12 may create a power use plan for update T6 so as to increase the amount of power consumption. At this time, the notification control section 12d may control notification so as to propose a power use plan related to the preference of the vehicle occupant according to the power use plan for update T6.

For example, as described above, the ECU 12 may have referenced the occupant information as the preference of the vehicle occupant from the storage section 12y and have learned in advance that “the owner of the vehicle 10 often watches a movie on an expressway”. In this case, the notification control section 12d of the ECU 12 may create an update power usage plan T6 for movie watching together with a message such as, “There is a margin in the amount of electric power. How about watching a movie?”, and may notify and propose the update power usage plan T6. The ECU 12 may apply the power use plan for update T6 when approval is obtained from the vehicle occupant. In this case, the ECU 12 performs control so that the content of the movie is subjected to display processing on the display apparatus 17 by the function of the execution section 12e.

### Second Modification

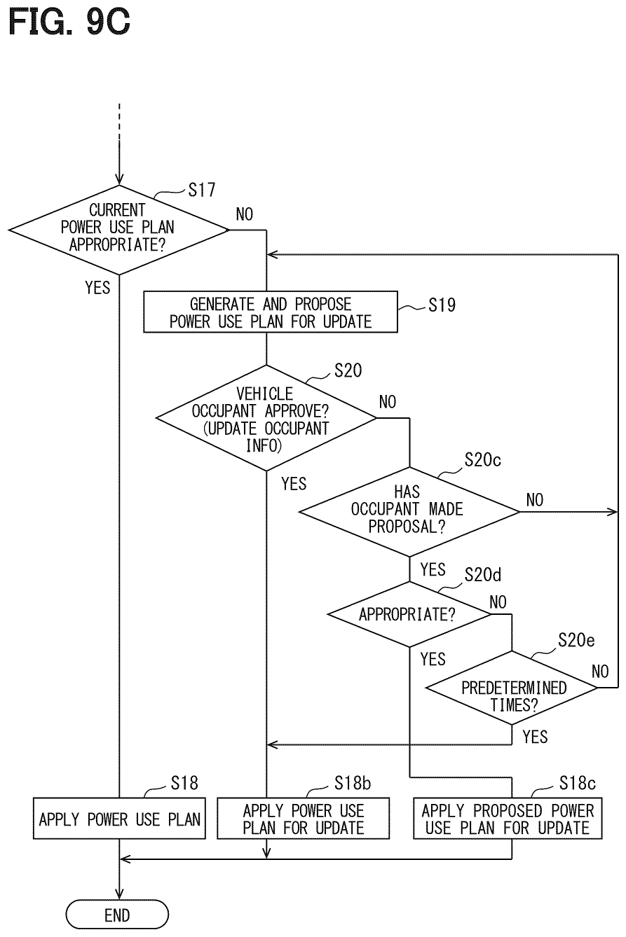

For example, as shown in FIG. 9A, when the vehicle occupant starts operating the vehicle 10, the ECU 12 creates power use plans K8, K8a for consuming a greater amount of electric power than the initial power use plan K7. In this case, for example, the ECU 12 may propose using the power use plan K8 that reflects the needs of the vehicle occupant up to a point T3 in the middle of a travel route, and using the power use plan K8a for saving a greater amount of electric power than the power use plan K8 from the middle of the travel of the vehicle 10. A specific example will be described. For example, it is assumed that the ECU 12 has obtained traffic jam information on the scheduled travel route of the vehicle 10 at the time of operation by the vehicle occupant. Further, during this period, the ECU 12 determines that there is a high possibility of use of various assist functions (e.g., a radar cruise control function (LCC)) related to driving operation during a traffic jam of the vehicle 10 by the vehicle occupant, or use of an entertainment device for movie watching to enjoy a boring traffic jam time.

When the ECU 12 predicts that the traffic jam will be resolved at the passing point T3 in the middle of the scheduled travel route with the lapse of time thereafter, it can be predicted that the needs for using electric power by the vehicle occupant, which are, in this case, the assist function such as the radar cruise control function and/or the use time of the entertainment device, will decrease after the point T3 at which the traffic jam will be resolved. In this case, the ECU 12 may create and propose the power use plan K8a in which the use of the assist function and the entertainment device is reduced from the passing point T3 in the middle of the scheduled travel route. This enables the needs of the vehicle occupants to be reflected as much as possible.

As described above, according to the present embodiment, the ECU 12 calculates the amount of electric power required for travel to the destination by calculating, together with the amount of electric power for travel to the destination, the amount of consumption-related electric power for a purpose not related to travel. Then, the ECU 12 determines whether the current power use plan (e.g., K1, K2) is appropriate on condition that the power consumption parameter has been updated before travel to the destination becomes impossible, and creates a power use plan for update (e.g., K2a) when determining that the current power use plan is not appropriate.

For this reason, even if some event occurs in which a large amount of electric power needs to be consumed when the amount of electric power is close to the upper usage limit, the system can consume electric power in response to this event. In this way, it is possible to perform power management appropriately while ensuring that the amount of electric power of the battery 11 until the destination is reached is equal to or greater than the remaining amount E.

If the ECU 12 merely proposes satisfying the request of the vehicle occupant, the remaining amount of electric power in the battery 11 may become insufficient. Therefore, the ECU 12 creates the power use plans for update K2a, K4, K6 based on a plurality of conditions, for example, the operation input information and the state of the vehicle occupant. This makes it possible to perform power management corresponding to the ever-changing needs of the vehicle occupants. With this processing, power management corresponding to the needs can be actively proposed to the vehicle occupant. The ECU 12 creates, notifies, and proposes the power use plans for update K2a, K4, K6, and the like, so that the vehicle occupant can be aware of the power management before or during travel.

Based on the preference priorities, the ECU 12 turns on or off an in-vehicle device operable until the destination is reached (e.g., the entertainment device or the broadcasting device), or proposes a parameter for an in-vehicle device in which a parameter can be set (e.g., an air conditioning setting in the air conditioner). This enables the needs of the vehicle occupant to be met.

### Third Modification of First Embodiment

FIG. 9B shows a modification of a part of FIG. 3. The ECU 12 creates and proposes the power use plan for update K2a in S19, but when the vehicle occupant does not approve the proposal in S20, the power use plan for update K2a is created again in S19. However, when no reply of approval has been received even though the ECU 12 has proposed the power use plan for update K2a to the vehicle occupant a predetermined plurality of times in S20b, YES may be determined in S20b, and the power use plan for update K2a may be executed by the execution section 12e regardless of the determination by the vehicle occupant. That is, when communication with the vehicle occupant is not successful, execution may be forcibly performed. In this example, the processing during stoppage of the vehicle is shown, but the processing in FIG. 6 can be applied in the same manner even during travel of the vehicle.

### Fourth Modification of First Embodiment

FIG. 9C shows a modification of a part of FIG. 3. In S17, the ECU 12 determines whether the current power use plan K1 is appropriate. At this time, for example, when it is determined that the destination cannot be reached due to the amount of electric power for travel or a lack of fuel, or the vehicle stops at a non-desired parking/stopping place due to the amount of electric power for travel or a lack of fuel, the use of the current power use plan K1 is determined to be inappropriate. Examples of such cases include a case where the vehicle is caught in a traffic jam while traveling on an expressway, or a route is set through a mountainous area or the like, and a determination is made that no charging facility is available and necessary charging cannot be performed. In this case, a point that “there is a problem in the current power use plan” may be displayed.

The ECU 12 creates and proposes the power use plan for update K2a in S19, but when the vehicle occupant does not approve the proposal in S20, the power use plan for update K2a is created again in S19. When there is no approval from the occupant, a proposal may be made by the occupant (YES in S20c). Examples of such a case include a case where the occupant requests continuation of the plan because the current power use plan K1 is comfortable. An example may be cited in which, although the power use plan for update K2a created in S19 has proposed changing the set temperature of the air conditioner to be high, there is a demand for maintaining the set temperature of the air conditioner to be low.

In S20d, the ECU 12 determines whether the proposal by the occupant is appropriate as the power use plan for update K2a. When the ECU 12 determines that the proposed power use plan for update K2a is appropriate, the ECU can apply and execute the proposed power use plan for update K2a. When the proposed power use plan for update K2a is not appropriate, it is determined in S20e as to whether the processing has been repeated a predetermined plurality of times. When the number of repetitions is less than the predetermined number of times, the processing returns to S19 to create the power use plan for update K2a again, and the processes in S20, S20c, and S20d are repeated.

When an inappropriate proposal has been made by the occupant in S20e, the predetermined plurality of times, the ECU 12 may determine YES in S20e and forcibly execute the power use plan for update K2a created in S19 regardless of the determination by the vehicle occupant. That is, when communication with the vehicle occupant is not successful, the created power use plan for update K2a may be forcibly executed. In this example, the processing during stoppage of the vehicle is shown, but the processing in FIG. 6 can be applied in the same manner even during travel of the vehicle.

### (Method for Changing Power Use Plan at Time of Resetting Destination, Waypoint, or the Like)

A destination of a navigation function may be reset based on an instruction from an occupant, or a waypoint may be set based on shopping, taking a break, or the like. There is a case where time is allocated to shopping, a break, or the like without setting a waypoint in accordance with a change based on the intention of the occupant, and in this case, the route may be changed during travel of the vehicle. Due to this influence, the time at which the final point of the destination is desired to be reached may be advanced or, on the contrary, may be delayed. When the destination or the waypoint is changed, similar processing can be implemented by performing the processing of FIG. 3 or FIG. 6 again.

### Second Embodiment

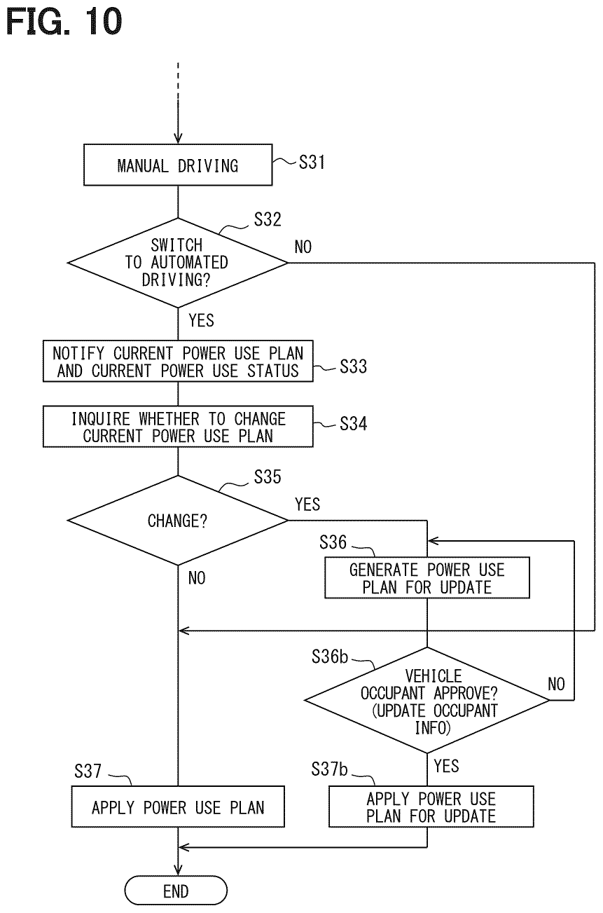

A second embodiment will be described with reference to FIG. 10 as well. In the present embodiment, as shown in S31 and S32 in FIG. 10, a case will be described where the ECU 12 detects that manual driving has been switched to automated driving through the operation input section 16.

When detecting that switching has been made to automated driving, the ECU 12 controls notification of the current power use plan (e.g., T5 in FIG. 8) and the current power use status in S33. In S34, the ECU 12 controls notification so as to inquire of the vehicle occupant whether to change the current power use plan T5. For example, during automated driving in the automated driving mode of the predetermined level or higher, the driver does not need to concentrate on driving.

The vehicle occupant has more time to stay in the vehicle interior and more opportunities to enjoy entertaining pastimes. Therefore, in S35, the ECU 12 controls notification so as to inquire about the necessity of changing the current power use plan T5, together with the current power use plan T5. In this case, when it is determined in S35 that there is a necessity for the change, the ECU 12 may create a power use plan for update T6 in S36 and control notification, together with the power use plan for update T6, with a message such as “How about enjoying a movie during automated driving?” When it is determined in S35 that there is no necessity for the change, the ECU 12 applies the power use plan T5 as it is in S37.

When the ECU 12 obtains the approval of the vehicle occupant in S36b, the ECU applies the power use plan for update T6 in S37b. When the approval of the vehicle occupant is not obtained, the processing returns to S36 to repeat the creation of the power use plan for update. When there is no reply from the vehicle occupant or in other cases, in S37b, the power use plan for update may be applied without obtaining approval. Here, the ECU 12 may automatically perform display control so that the content of the movie is subjected to display processing on the display apparatus 17 as necessary by the function of the execution section 12e.

During automated driving, particularly, the vehicle occupant often wants to consume electric power. According to the present embodiment, management can be performed so that power can be intensively used during automated driving or the like. The needs of the vehicle occupants can be responded to at any timing during travel of the vehicle 10.

### Third Embodiment

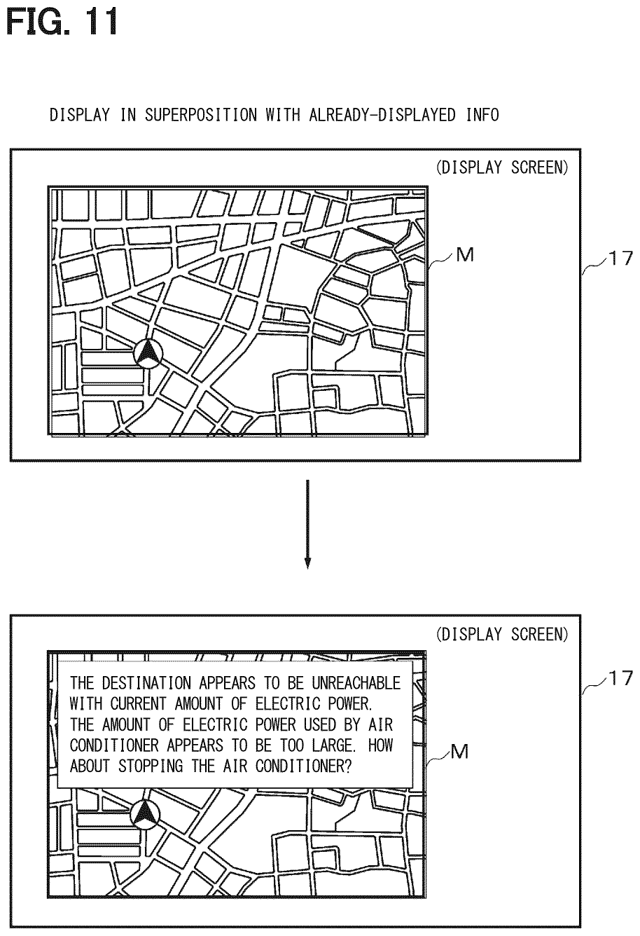

A third embodiment will be described with reference to FIGS. 11 to 14 as well. When executing the navigation function after the operation input of the destination, the ECU 12 performs display processing on the content of the map information M on the display screen of the display apparatus 17 together with the current position mark of the vehicle 10, as shown in the upper part of FIG. 11.

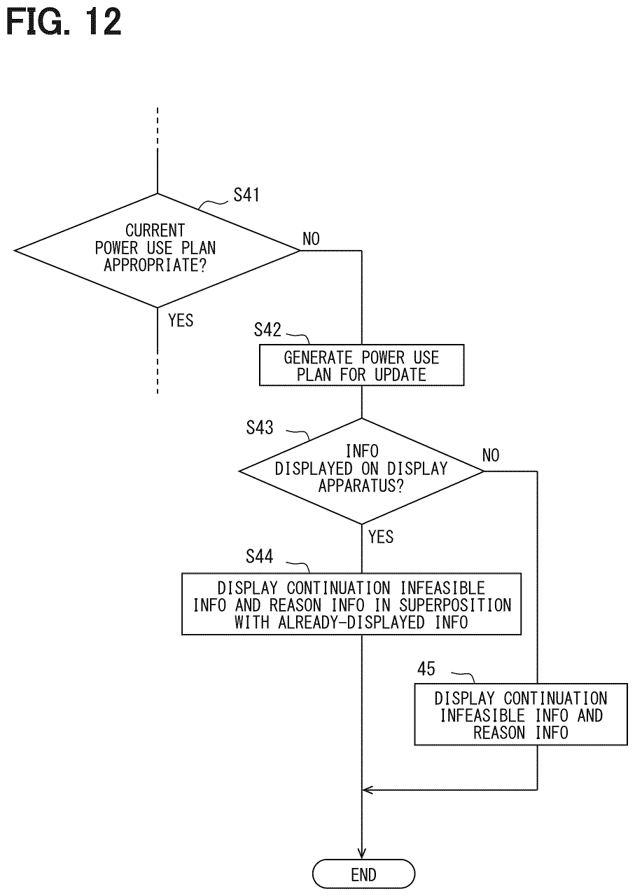

As shown in FIG. 12, during travel of the vehicle 10, the ECU 12 determines whether the current power use plan (e.g., K3 in FIG. 7) is appropriate in S41. When it is determined that the current power use plan K3 cannot be continued and is not appropriate, the ECU 12 creates a power use plan for update K4 in S42.

In step S43, the ECU 12 determines whether content information is displayed on the display screen of the display apparatus 17. When the content is already displayed, the notification control section 12d of the ECU 12 may display the continuation infeasible information and the reason information on the display screen of the display apparatus 17 in superposition with the map information M to serve as the already-displayed information, which has already been displayed, in S44.

In the example of FIG. 11, on the display apparatus 17, the ECU 12 performs interrupt display processing, such as “The destination is unreachable with the current power use plan.” as continuation infeasible information, and “The amount of electric power used by the air conditioner appears to be too large.” as reason information. As proposal information in superposition with these pieces of information, the ECU 12 may perform display processing, such as “How about stopping the air conditioner?”.

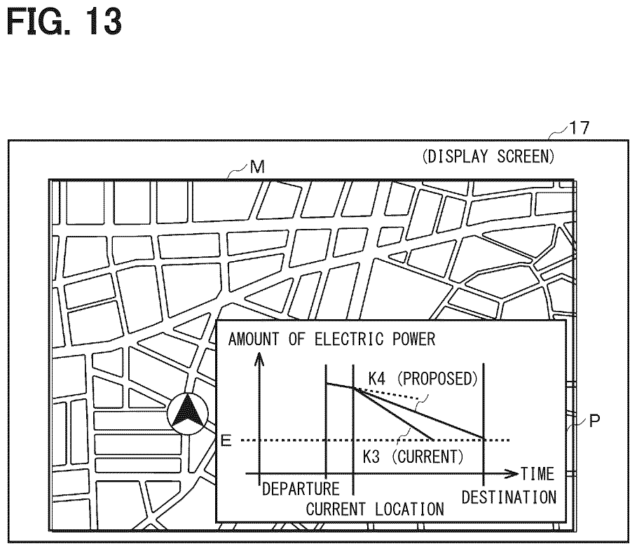

As shown in FIG. 13, the notification control section 12d of the ECU 12 may perform display processing by graphing the current power use plan K3 and the power use plan for update K4, and superimposing a chart P on the map information M as continuation infeasible information on a part of the display screen of the display apparatus 17. Here, the form in which the chart P is superimposed on the map information M has been exemplified, but display processing may be performed by superimposing the chart P on surrounding camera information obtained by imaging the surroundings of the vehicle 10 or various types of video information such as a movie and a television broadcast.

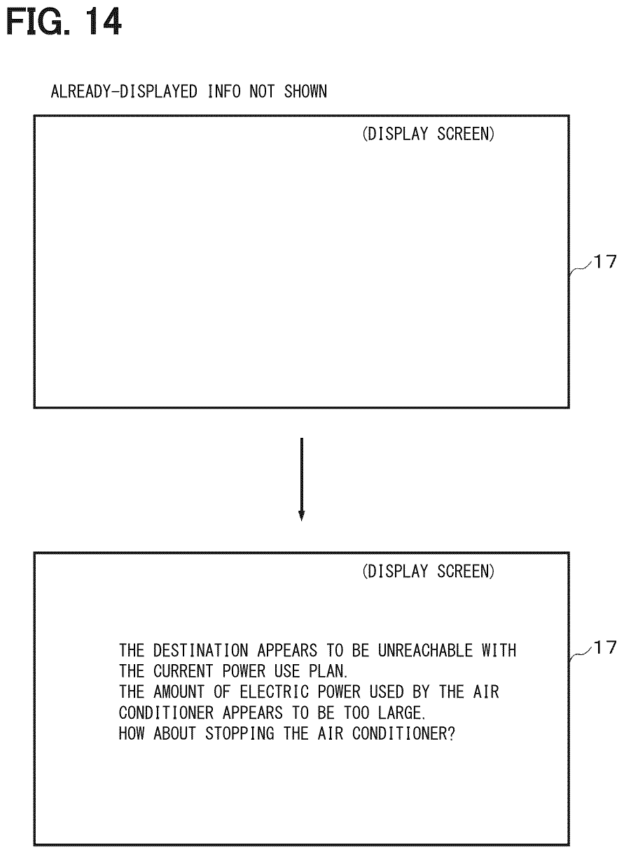

Conversely, when determining that the content is not displayed on the display apparatus 17 in S43 of FIG. 12, the ECU 12 proceeds to S45. In S45, the ECU 12 performs display control of the display apparatus 17 to display the continuation infeasible information indicating that the current power use plan (e.g., K3 in FIG. 7) cannot be continued and the reason information indicating the reason the current power use plan cannot be continued. At this time, character information may be displayed or a graph or the like may be drawn, and as shown in FIG. 14, the ECU 12 may perform display processing on the continuation infeasible information and the reason information on the entire display screen of the display apparatus 17.

The notification control section 12d of the ECU 12 may display on a part of the display screen of the display apparatus 17, or may display only a result as to whether the current power use plan (e.g., K3 in FIG. 7) can be continued. The notification control section 12d of the ECU 12 may change the display mode in accordance with the remaining amount of electric power of the battery 11 when the destination is reached. As the remaining amount of electric power when the destination is reached becomes smaller, an alert color or a warning color with a higher degree of attention-calling warning may be used to perform display processing.

### Fourth Embodiment

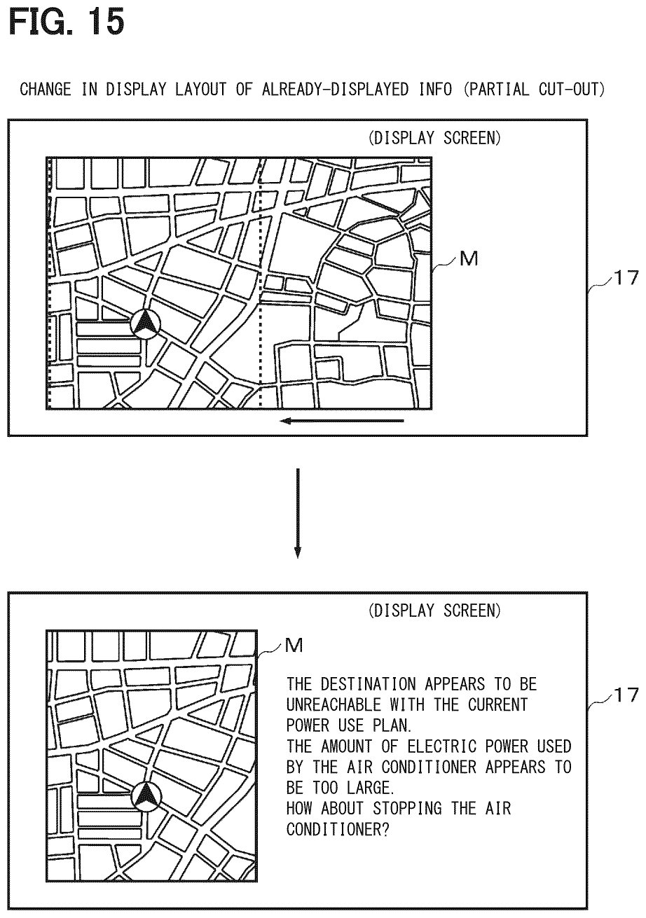

A fourth embodiment will be described with reference to FIGS. 15 to 18 as well. When executing the navigation function after the operation input of the destination, the ECU 12 performs display processing on the content of the map information M on the display screen of the display apparatus 17 together with the current position mark of the vehicle 10 as shown in the upper part of FIG. 15.

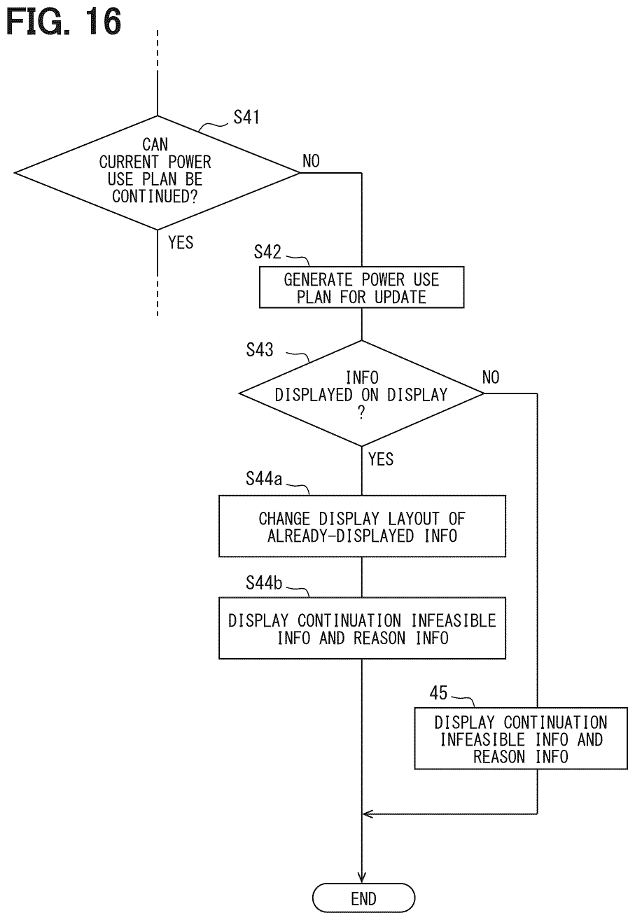

As shown in FIG. 16, during travel of the vehicle 10, the ECU 12 determines whether the current power use plan (e.g., here, K3 in FIG. 7) is appropriate in S41. When it is determined that the current power use plan K3 cannot be continued and is not appropriate, the ECU 12 creates a power use plan for update K4 in S42.

In step S43, the ECU 12 determines whether content information is displayed on the display screen of the display apparatus 17. When the content has already been displayed, the notification control section 12d of the ECU 12 changes the display layout of the already-displayed information in S44a, and displays the continuation infeasible information and the reason information in an area different from an area in which the already-displayed information is displayed in S44b.

For example, as shown in the upper part of FIG. 15, a case is considered in which the map information M is displayed on the entire display screen of the display apparatus 17 together with the current position mark of the vehicle 10. In this case, the ECU 12 may cut out a part of the left-half portion of the map information M, display the remaining part, leave the cut-out portion blank, and use this blank area to perform display processing on the continuation infeasible information and the reason information in the right-half portion of the display screen.

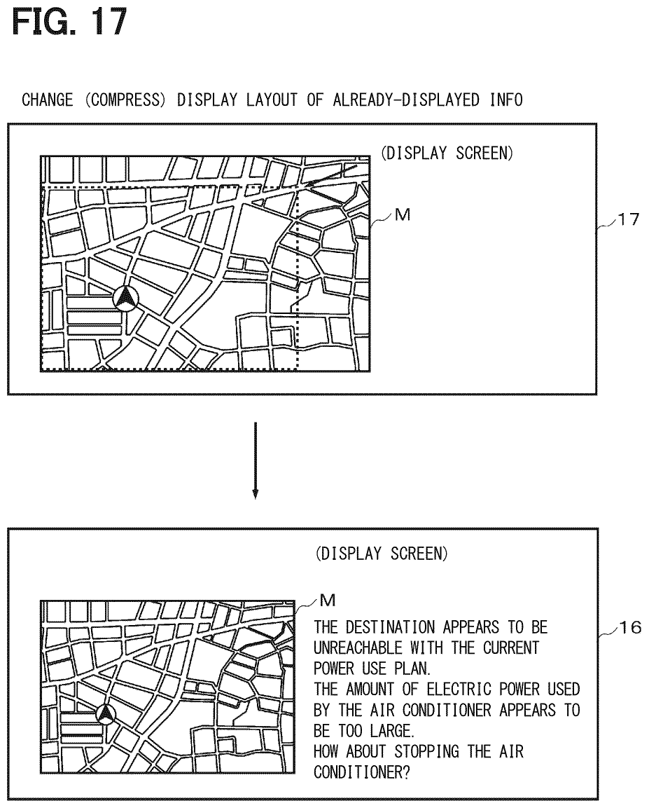

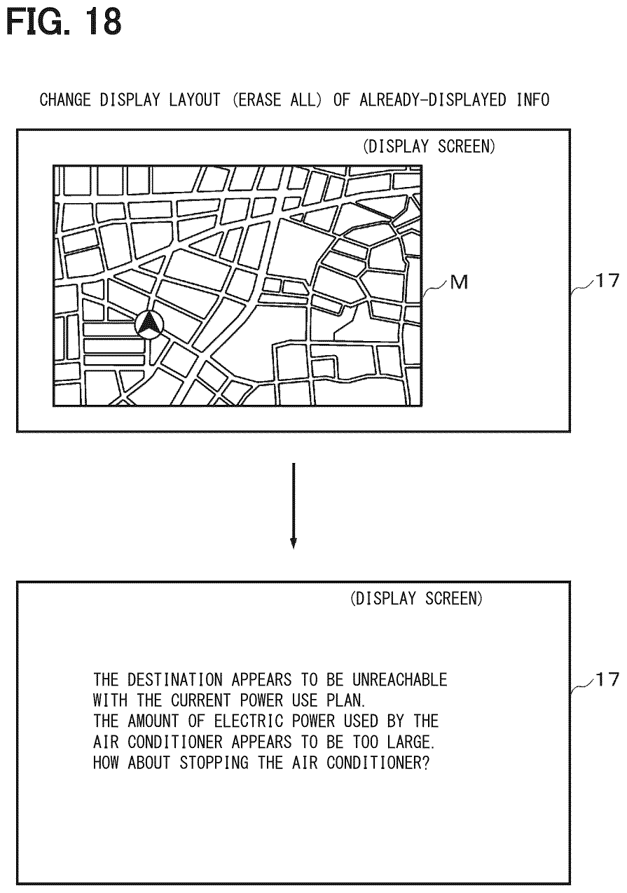

In addition, as shown in the lower part of FIG. 17, the ECU 12 may reduce the overall scale of the map information M and use the space made available by the reduction to perform display processing on the continuation infeasible information and the reason information on the display screen. In addition, as shown in the lower part of FIG. 18, the ECU 12 may delete the entire map information M and use the space made available to perform display processing on the continuation infeasible information and the reason information on the entire display screen. This enables warning so as to make the vehicle occupant become aware of power consumption in the vehicle interior.

Further, a modification of the proposal for changing the power use plan will be described. It may be troublesome for the user if a change proposal is made every time a specific condition is satisfied, as described above. Therefore, it is desirable to make a proposal, using the current driving status of the vehicle occupant and the history information of the past operation input. This leads to a level of joy that exceeds the trouble. The operation input information of the vehicle occupant in response to the proposal may be accumulated as learning data, and whether to make the proposal may be determined based on the learning data. When a positive reaction to the proposal is received, the proposal frequency may be increased, and on the contrary, when a negative reaction is received, the proposal frequency may be decreased.

### Fifth Embodiment

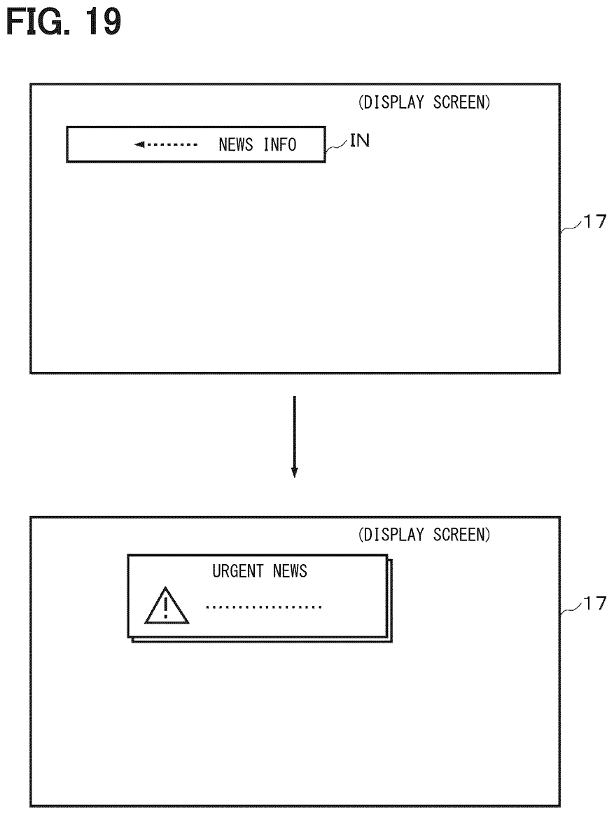

A fifth embodiment will be described with reference to FIG. 19 as well. When displaying various types of information, the notification control section 12d of the ECU 12 may set and display an information area IN on a part of the display screen of the display apparatus 17, as shown in the upper part of FIG. 19. In the information area IN, information that does not require an operation of the occupant may be displayed. For example, notification information to the occupant at the time of receiving an email, such as “Message received.”, general news information, and the like may be displayed in a horizontal direction.

If some urgent information is generated, the notification control section 12d of the ECU 12 may pop up information having a high degree of urgency or information requesting an operation by the occupant (for example, whether to change the power use plan (e.g., K1 to K2a) in the embodiment described above). At this time, as shown in the lower part of FIG. 19, the notification control section 12d of the ECU 12 may display the emergency information in a floating manner so as to make the emergency information stand out, may display the emergency information together with an icon indicating attention calling, such as an exclamation mark, and may further notify the emergency information together with a sound for calling attention.

The present disclosure is not limited to the embodiments described above, but may be implemented in various modified forms, and is applicable to various embodiments without departing from the gist thereof. The methods performed by the ECUs 12 and 13 described in the present disclosure may be realized by a dedicated computer provided by configuring a processor and memory programmed to execute one or more functions embodied by a computer program. Alternatively, the methods performed by the ECUs 12 and 13 described in the present disclosure may be realized by a dedicated computer provided by configuring a processor with one or more dedicated hardware logic circuits. Alternatively, the control apparatus and methods described in the present disclosure may be realized by one or more dedicated computers configured by a combination of a processor and memory programmed to execute one or more functions and a processor configured with one or more hardware logic circuits. Furthermore, the computer program may be stored as instructions executable by a computer on a computer-readable, non-transitory, tangible recording medium.

What is claimed is:

1. A power management system comprising:
at least one of (i) a circuit and (ii) a processor with a memory storing computer program code executable by the processor, the at least one of the circuit and the processor configured to cause the power management system to:
calculate an amount of electric power for travel and an amount of consumption-related electric power based on a power consumption parameter representing electric power consumed in a vehicle, the amount of electric power for travel being consumed while the vehicle is traveling until reaching a destination, the amount of consumption-related electric power being required to execute a function of an in-vehicle device used until the destination is reached;
create a power use plan for traveling to the destination based on the amount of electric power for travel and the amount of consumption-related electric power; and
determine, based on the power consumption parameter, whether it is appropriate to use a current power use plan,
wherein
an updated power use plan that is different from a current power use plan is created when it is determined that the current power use plan is inappropriate.

2. The power management system according to claim 1, wherein:
a calculation section is implemented by the at least one of (i) the circuit and (ii) the processor with a memory storing computer program code executable by the processor configured to calculate the amount of electric power for travel and the amount of consumption-related electric power;
a generation section is implemented by the at least one of (i) the circuit and (ii) the processor with a memory storing computer program code executable by the processor configured to create the power use plan; and
a determination section is implemented by the at least one of (i) the circuit and (ii) the processor with a memory storing computer program code executable by the processor configured to determine whether it is appropriate to use the current power use plan; and
the generation section creates an updated power use plan that is different from a current power use plan, when the determination section determines that the current power use plan is inappropriate.

3. The power management system according to claim 2, wherein
the power consumption parameter includes an element for which electric power is consumed based on at least one of following pieces of occupant information:
information on a driving operation of the vehicle by a driver;
information on an operation of the in-vehicle device by a vehicle occupant;
a state of the vehicle occupant; and
a preference of the vehicle occupant.

4. The power management system according to claim 2, wherein
the at least one of (i) the circuit and (ii) the processor with a memory storing computer program code executable by the processor is further configured to implement
a notification control section configured to control notification to a vehicle occupant of a power use plan,
wherein
the notification control section notifies the vehicle occupant of the current power use plan, and controls the notification so as to urge carrying out of the current power use plan.

5. The power management system according to claim 2, wherein
the at least one of (i) the circuit and (ii) the processor with a memory storing computer program code executable by the processor is further configured to implement
a notification control section configured to control notification to a vehicle occupant of a power use plan,
wherein
when the calculation section determines, based on a total amount of power consumption calculated under an assumption that the current power use plan is carried out until the destination is reached, that there is a margin equal to or greater than a predetermined remaining amount including a margin amount of electric power,
the generation section creates an updated power use plan that increases the amount of power consumption based on a preference of the vehicle occupant, and
the notification control section controls notification so as to propose the updated power use plan related to the preference of the vehicle occupant.

6. The power management system according to claim 2, wherein
the at least one of (i) the circuit and (ii) the processor with a memory storing computer program code executable by the processor is further configured to implement
a notification control section configured to control notification to a vehicle occupant of a power use plan,
wherein
when manual driving is switched to automated driving, the notification control section controls notification of the current power use plan and a current power use status and controls notification so as to inquire of the vehicle occupant whether to change the current power use plan.

7. The power management system according to claim 4, wherein
a display apparatus for display control of content by the notification control section is connected, and
in a case where the determination section determines that continuation of the current power use plan is impossible and that the current power use plan is inappropriate,
when the content is not being displayed on the display apparatus, the notification control section displays, on the display apparatus, continuation infeasible information indicating that the current power use plan cannot be continued, and reason information indicating a reason for impossibility of continuation, and
when the content is already been displayed on the display apparatus, the continuation infeasible information and the reason information are displayed on the display apparatus in superposition with already-displayed information that has already been displayed.

8. The power management system according to claim 4, wherein
a display apparatus for display control of content by the notification control section is connected, and
in a case where the determination section determines that continuation of the current power use plan is impossible and that the current power use plan is inappropriate, the notification control section changes display layout of already-displayed information, and the notification control section displays, on the display apparatus, the already-displayed information, continuation infeasible information indicating that the current power use plan cannot be continued, and reason information indicating a reason for impossibility of continuation.

9. The power management system according to claim 2, wherein,
when the determination section determines that the current power use plan is inappropriate, the generation section creates the updated power use plan so as to reduce use of a function of adjusting an environment in the vehicle.

10. The power management system according to claim 9, wherein
an occupant detection section that detects a seat in which a vehicle occupant is present is connected, and
when the determination section determines that the current power use plan is inappropriate, the generation section creates the updated power use plan so as to adjust an output of air conditioning to a seat from which the vehicle occupant is absent by adjusting an environment inside the vehicle.

11. The power management system according to claim 9, wherein
an occupant detection section that detects a position of a body of a vehicle occupant is connected,
when the determination section determines that the current power use plan is inappropriate, the generation section creates the updated power use plan so as to adjust use of electric power by adjusting an output of an air conditioning to blow air in a limited manner only to a part of the body of the vehicle occupant.

12. The power management system according to claim 9, wherein
an occupant detection section that detects a seat on which a vehicle occupant is seated is connected, and
when the determination section determines that the current power use plan is inappropriate, the generation section creates the updated power use plan so as to adjust use of electric power by controlling an output of a temperature adjustment function of a seat cushion on which the vehicle occupant is seated and adjusting a thermal feeling of a part of a body of the vehicle occupant.

13. The power management system according to claim 2, wherein
the at least one of (i) the circuit and (ii) the processor with a memory storing computer program code executable by the processor is further configured to implement
an execution section configured to execute the updated power use plan without waiting for a determination by an occupant of the vehicle.

14. The power management system according to claim 2, wherein
the at least one of (i) the circuit and (ii) the processor with a memory storing computer program code executable by the processor is further configured to implement
an execution section configured to execute the updated power use plan regardless of a determination by an occupant of the vehicle, when no reply of approval has been received even though the updated power use plan has been proposed to an occupant of the vehicle a predetermined plurality of times, or when an inappropriate proposal has been made to the occupant as the updated power use plan a predetermined number of times.

15. The power management system according to claim 2, wherein
the determination section determines that use of the current power use plan is inappropriate when a predetermined standard defined from a viewpoint of security or safety is exceeded, and
the generation section creates the updated power use plan when the use is determined to be inappropriate.

16. A power management method comprising:
calculating, by a calculation section, an amount of electric power for travel and an amount of consumption-related electric power based on a power consumption parameter representing electric power consumed in a vehicle, the amount of electric power for travel being consumed while the vehicle is traveling until reaching a destination, the amount of consumption-related electric power being required to execute a function of an in-vehicle device used until the destination is reached;
creating, by a generation section, a power use plan for traveling to the destination based on the amount of electric power for travel and the amount of consumption-related electric power;
determining, based on the power consumption parameter, by a determination section, whether it is appropriate to use a current power use plan; and
creating, by the generation section, an updated power use plan that is different from a current power use plan, when the determination section determines that the current power use plan is inappropriate.

17. A non-transitory computer readable storage medium storing a power management program that causes a power management system to execute procedures of:
calculating, by a calculation section, an amount of electric power for travel and an amount of consumption-related electric power based on a power consumption parameter representing electric power consumed in a vehicle, the amount of electric power for travel being consumed while the vehicle is traveling until reaching a destination, the amount of consumption-related electric power being required to execute a function of an in-vehicle device used until the destination is reached;
creating, by a generation section, a power use plan for traveling to the destination based on the amount of electric power for travel and the amount of consumption-related electric power;
determining, based on the power consumption parameter, by a determination section, whether it is appropriate to use a current power use plan; and
creating, by the generation section, an updated power use plan that is different from a current power use plan, when the determination section determines that the current power use plan is inappropriate.
